(19) United States
(12) Patent Application Publication
(10) Pub. No.: US 2026/0242130 A1
(43) Pub. Date: Aug. 20, 2026

(54) MODULAR TRASH BIN

(71) Applicant: Sunbelt Rentals, Inc., Fort Mill, SC (US)

(72) Inventor: Jeff Bair, Fort Mill, SC (US)

(73) Assignee: Sunbelt Rentals, Inc., Fort Mill, SC (US)

(21) Appl. No.: 19/053,527

(22) Filed: Feb. 14, 2025

(51) Int. Cl. B65F 1/12; B65F 1/14; B65F 3/26

(52) U.S. Cl. CPC B65F 1/122; B65F 1/1473; B65F 3/26; B65F 2220/1063; B65F 2220/12

(57) ABSTRACT

A modular trash bin includes a base, a plurality of side walls, and a top wall. The plurality of side walls are attachable to the base, and the top wall is attachable to the plurality of side walls. The top wall and the plurality of side walls each include a frame and mesh material, and the base, the plurality of side walls, and the top wall define an enclosure configured to receive waste material. At least one of the plurality of side walls defines an access opening for loading the waste material into the enclosure and unloading the waste material from the enclosure. The base is attachable to and detachable from a vehicle for securing the modular trash bin relative to the vehicle.

### FIELD OF THE INVENTION

This application generally relates to trash bins for storage, transportation, and disposal of various waste.

### BACKGROUND

Various types of containers exist for hauling large quantities of waste to a disposal site, with common types including roll-off dumpsters and trash trailers.

Roll-off dumpsters generally have solids walls and a solid floor but an open top. While the walls and floor of such dumpsters provide some containment of debris, open-top nature of conventional dumpsters results in any waste within the dumpster being only partially contained and/or some users may fill the dumpster with trash above the height of the walls. Dumpsters may be carried by a specialized truck, which includes equipment for loading and unloading the dumpster, but the mobility of dumpsters is limited-in the absence of such specialized trucks, dumpsters generally cannot be moved, and the ability to transport such dumpsters is reliant on the availability of the specialized trucks.

Trash trailers are generally a rectangular cage with wheels and designed for bumper pull. Similar to dumpsters, a single trash trailer may be pulled by a single vehicle. Unlike dumpsters, the trash trailers may securely contain material within the cage. However, because the cage is the trailer itself, most trailer designs do not allow for complete dumping and require a person to physically step into the unit and rake debris out.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a modular trash bin includes a base, a plurality of side walls, and a top wall. The top wall and/or at least one of the plurality of side walls may include a frame and a mesh material. In some embodiments, the plurality of side walls and the top wall have a deployed configuration and a stowed configuration relative to the base, where, in the deployed configuration, the plurality of side walls and the top wall define an enclosure with the base configured to receive waste material, and, in the stowed configuration, the enclosure is not defined. In some embodiments, at least one of the plurality of side walls defines an access opening for loading the waste material into the enclosure and unloading the waste material from the enclosure in the deployed configuration.

According to some embodiments, a modular trash bin includes a base, a plurality attached to the base, and a top wall attached to each of the plurality of side walls opposite from the base. The top wall and a majority of the plurality of side walls each include a frame and mesh material, and the base, the plurality of side walls, and the top wall define an enclosure configured to receive waste material. In certain embodiments, at least one of the plurality of side walls defines an access opening for loading the waste material into the enclosure and unloading the waste material from the enclosure. In various embodiments, the modular trash bin is separable from a trailer or vehicle configured to carry the modular trash bin.

According to certain embodiments, a modular trash bin includes a base with a front end, a back end, and a side extending between the front end and the back end, where the side comprises at least two fork pockets. The modular trash bin also includes a plurality of side walls attached to the base and a top wall attached to the plurality of side walls opposite from the base. The top wall and/or at least one of the plurality of side walls may include a frame and a mesh material, and the plurality of side walls and the top wall define an enclosure with the base configured to receive waste material. In some embodiments, at least one of the plurality of side walls defines an access opening for loading the waste material into the enclosure and unloading the waste material from the enclosure.

According to certain embodiments, a modular trash bin includes a base and a plurality of side walls, where the plurality of side walls include a front side wall, a back side wall, and lateral side walls extending between the front side wall and the back side wall. In certain embodiments, a length of the front side wall is less than a length of the back side wall. The modular trash bin also includes a top wall attached to each of the plurality of side walls opposite from the base. The top wall and a majority of the plurality of side walls each include a frame and mesh material, and the base, the plurality of side walls, and the top wall define an enclosure configured to receive waste material. In certain embodiments, at least one of the plurality of side walls defines an access opening for loading the waste material into the enclosure and unloading the waste material from the enclosure.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a modular trash bin according to embodiments.

FIG. 2 is another view of the modular trash bin of FIG. 1.

FIG. 3 is a back view of the modular trash bin of FIG. 1.

FIG. 4 is a top view of the modular trash bin of FIG. 1.

FIG. 5 is a side view of the modular trash bin of FIG. 1.

FIG. 6 illustrates the modular trash bin of FIG. 1 on a vehicle.

FIG. 7 is another view of the modular trash bin of FIG. 1 on the vehicle.

FIG. 8 is another view of the modular trash bin of FIG. 1 on the vehicle.

FIG. 9 illustrates the modular trash bin of FIG. 1 partially loaded on the vehicle.

FIG. 10 illustrates the modular trash bin of FIG. 1 unloaded from the vehicle.

FIG. 11 illustrates the modular trash bin of FIG. 1 in a deployed configuration.

FIG. 12 illustrates the modular trash bin of FIG. 1 in a stowed configuration.

FIG. 13 illustrates a trash transport system with a plurality of modular trash bins of FIG. 1.

FIG. 14 illustrates a trash transport system with a plurality of modular trash bins of FIG. 1.

### DETAILED DESCRIPTION

Described herein are modular trash bins for storage, transportation, and disposal of various waste, and associated systems and methods for transporting such modular trash bins.

In certain embodiments, the modular trash bins described herein define an enclosure for securely containing material while also being separable from a trailer, vehicle, or other transport device for conveying the modular trash bin. In various embodiments, the modular trash bins are not bumper pull and are instead carried by a transport device (e.g., a trailer and/or a vehicle), and a bumper pull is not considered carrying as used herein. In certain embodiments, the modular trash bins described herein include fork pockets (or fork tunnels) configured to accommodate the forks of a forklift or similar equipment. Additionally, or alternatively, the modular trash bins described herein include roll-off wheel assemblies. The modular trash bins thus allow for improved and more versatile transport of the modular trash bins compared to traditional approaches, and further may facilitate movement using a forklift (or similar equipment) at a location without requiring a particular truck.

In some embodiments, the modular trash bins described herein include a top wall and a plurality of side walls, and at least one of the top wall and/or one of the side walls includes a frame and mesh material. Optionally, the top wall and/or a majority of the side walls (optionally all of the side walls) include the frame and mesh material. The frame may be constructed from various materials as desired, such as but not limited to metals, composite material, wood, combinations thereof, and/or as otherwise desired. As used herein, mesh material may refer to wire mesh, bars, and/or other similar materials suitable for creating an enclosed space with visible openings or gaps that allow for ventilation while preventing escape of material contained within the enclosed space. The cage design on the majority of the side walls and the top wall may facilitate visibility of potentially hazardous materials in the receptacle, among other benefits.

In various embodiments, the modular trash bins described herein include a tapered shape such that the modular trash bin is narrower at a front end and wider at the back end. In such embodiments, the modular trash bin may allow for and/or facilitate an easier and/or cleaner dump of material (e.g., allowing for complete or substantially complete dumping from the modular trash bin while minimizing and/or eliminating the traditional requirement for a person to physically step into the unit and rake debris out). Optionally, the tapered shape of the modular trash bins may facilitate nesting of a plurality of trash bins, thereby providing improved transport and/or storage of a plurality of modular trash bins.

In certain embodiments, the modular trash bins described herein may have deployed and stowed configurations such that an enclosure is selectively defined. In various embodiments, the deployed and stowed configurations may allow for the modular trash bins to be quickly assembled and disassembled. Additionally, or alternatively, the deployed and stowed configurations may provide improved stacking or nesting for easier transport and/or storage, optionally of multiple modular trash bins by a single vehicle or transport system.

Compared to traditional approaches, the modular trash bins described herein provide improved containment of a material, improved transport versatility, improved dumping, and/or improved stacking and/or storage, among other benefits. Various other benefits and advantages may be realized with the systems and methods described herein, and the aforementioned benefits and advantages should not be considered limiting.

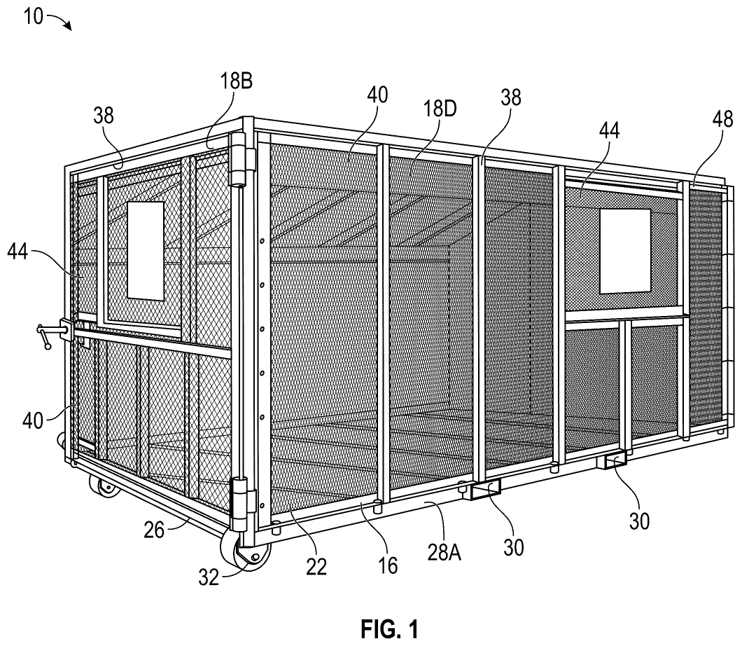

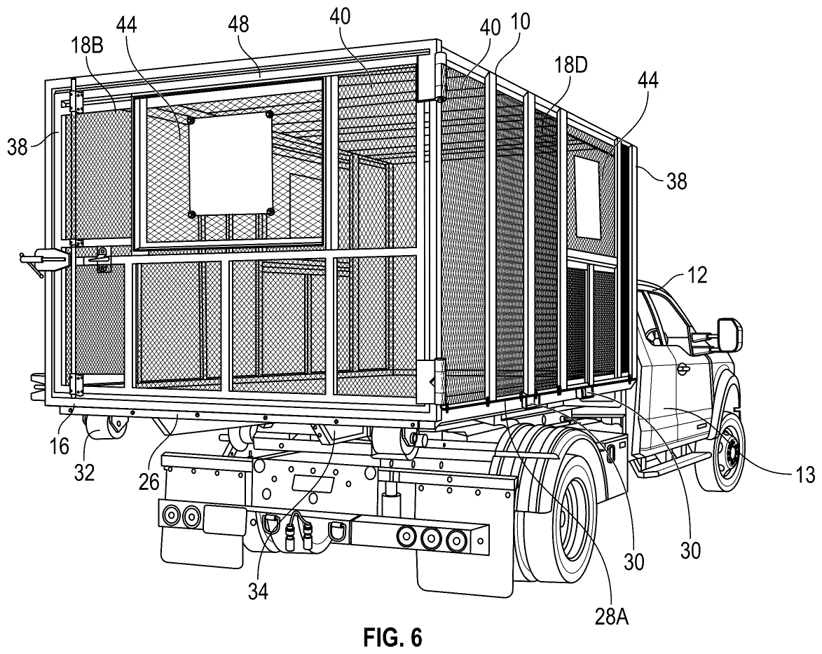

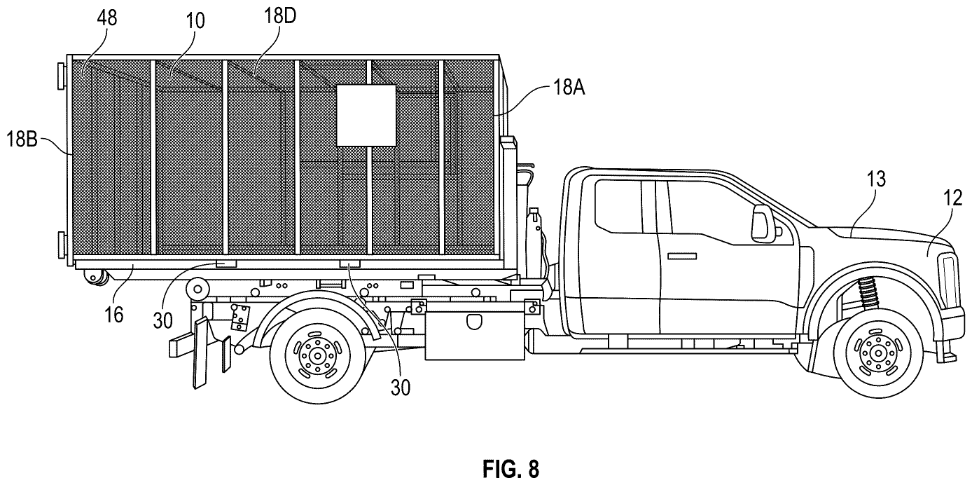

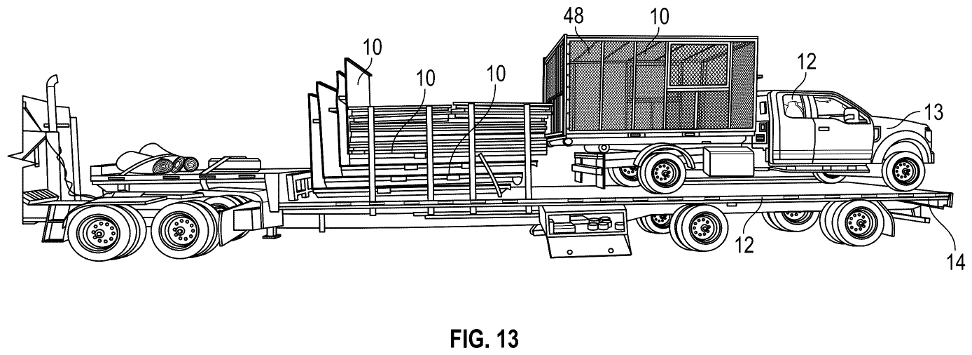

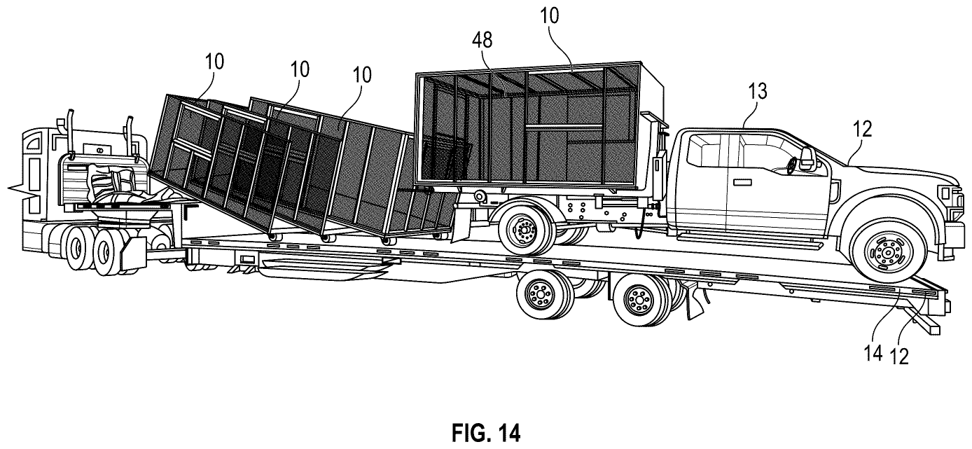

FIGS. 1-12 illustrate a modular trash bin 10 according to embodiments. The modular trash bin 10 may be utilized to store, transport, and dispose of various waste material as desired. In certain embodiments, the modular trash bin 10 is separable (e.g., may be loaded and unloaded) from a transport device 12, such as a but not limited to a vehicle 13 (see, e.g., FIGS. 6-10) and/or a trailer 14 (see, e.g., FIGS. 13 and 14).

The modular trash bin 10 generally includes a base 16, a plurality of side walls 18, and a top wall 20.

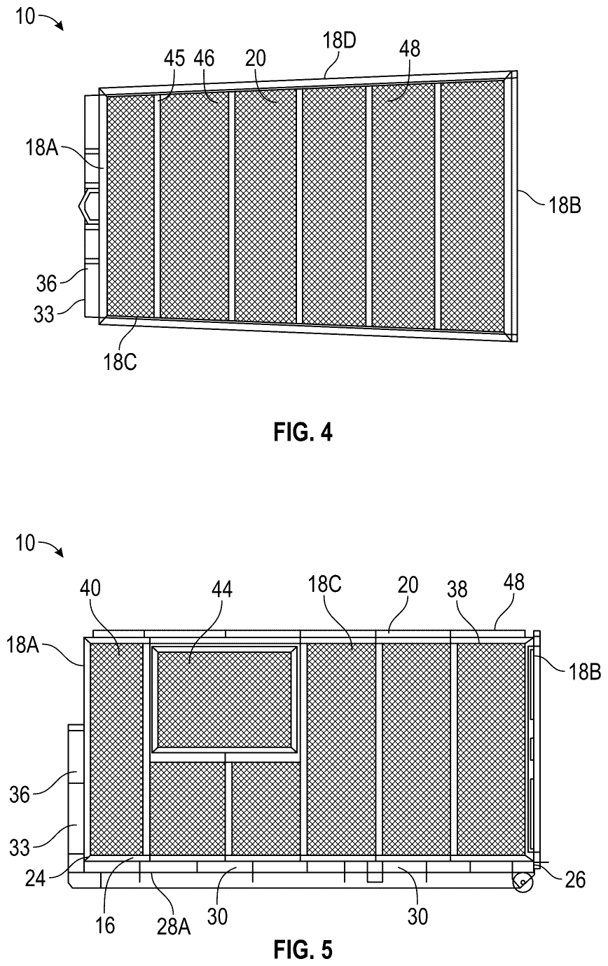

The base 16 includes a support surface 22 and may be constructed from various materials as desired. As non-limiting examples, the base 16 may be constructed from various metals, composite material, wood, combinations thereof, and/or as otherwise desired. Optionally, the base 16 may be constructed from a mesh material. In certain embodiments, the base 16 includes a front end 24, a back end 26, and lateral sides 28A-B which extend from the front end 24 and the back end 26. In certain embodiments, and as best illustrated in FIG. 4, a width of the back end 26 is greater than a width of the front end 24. In this regard, the base 16 may be narrower at the front end 24 and wider at the back end 26, which may facilitate dumping and/or cleaning of material from the modular trash bin 10.

In some embodiments, and as illustrated in FIG. 1, for example, one or more of the lateral sides 28A-B may include one or more fork pockets 30 between the front end 24 and the back end 26. In some embodiments, and as illustrated in FIG. 1, the fork pockets 30 are oriented in a direction that is transverse and/or not parallel to a front-to-back direction between the front end 24 and the back end 26. Additionally, or alternatively, one or more fork pockets 30 may be provided at the front end 24 and/or the back end 26, and/or the one or more fork pockets may be oriented in a direction parallel to the front-to-back direction and/or in any other orientation as desired. In one non-limiting example, the modular trash bin 10 may include both side fork pockets 30 and end fork pockets 30.

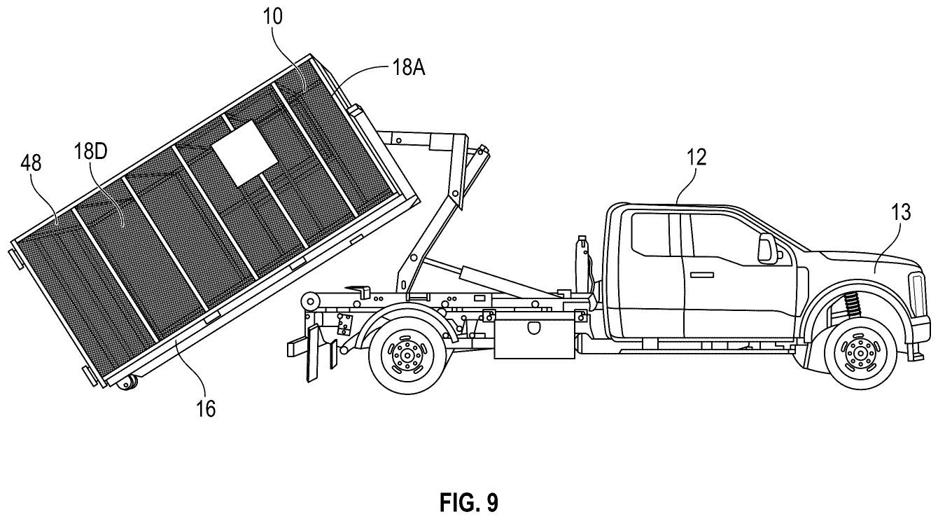

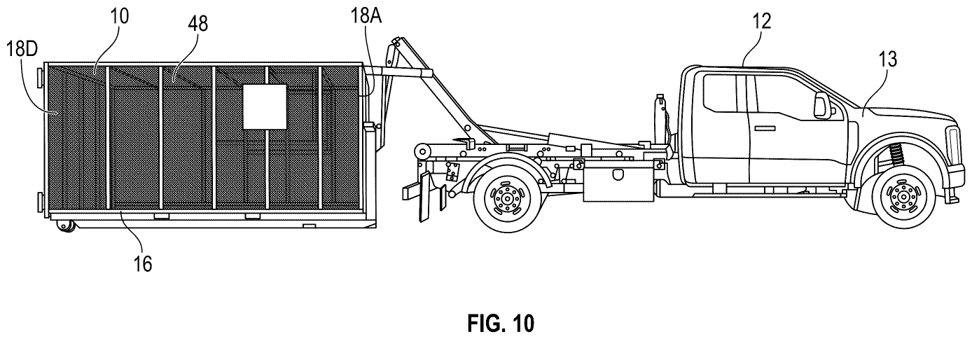

Optionally, one or more roll-off wheel assemblies 32 is provided at or proximate to the back end 26 of the base 16, and the roll-off wheel assemblies 32 may allow for roll-off (or roll-on) in the front-to back direction. In certain embodiments, the fork pockets 30 with such an orientation may provide expanded transport versatility for the modular trash bin 10. As non-limiting examples, the modular trash bin 10 may be loaded/unloaded from the transport device 12 in a side-to-side direction (via a forklift using the fork pockets 30) or in the front-to-back direction (using the roll-off wheel assemblies 32—see, e.g., FIGS. 9-10). Additionally, the fork pockets 30 may allow for improved movement at a given location without requiring a specialized transport truck, and a forklift (or similar device) may engage the fork pockets 30 to move the modular trash bin 10.

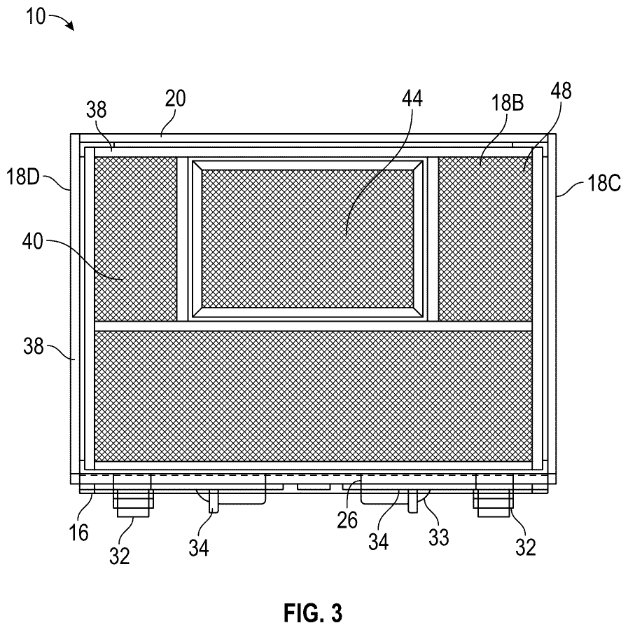

Optionally, the base 16 includes one or more engagement features 33 to facilitate engagement with the transport device 12 when the modular trash bin 10 is loaded on the transport device 12. As illustrated in FIGS. 3 and 5, for example, such engagement features 33 may include one or more rails 34, a hook feature 36, combinations thereof, and/or other suitable features as desired.

The plurality of side walls 18 may include a front side wall 18A, a back side wall 18B, and lateral side walls 18C-D. In certain embodiments, and as illustrated in FIGS. 4-5, a length of the front side wall 18A (measured in the direction of the width of the front end 24 of the base 16) is less than a length of the back side wall 18B. In certain embodiments, lengths of the lateral side walls 18C-D is greater than the length of the back side wall 18B, although they need not be in other embodiments. In various embodiments, the shorter front side wall 18A may provide the modular trash bin 10 with a narrower front end and a wider back end, which as previously mentioned, may facilitate dumping of material from the modular trash bin 10.

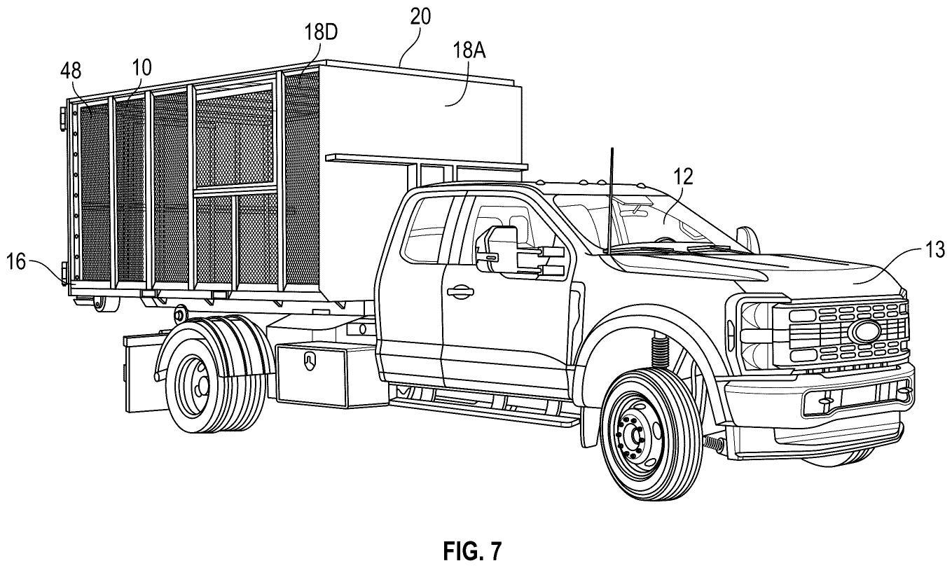

In various embodiments a majority of the side walls 18 (optionally all of the side walls 18) include a frame 38 and mesh material 40. The frame 38 may be various material suitable for supporting the mesh material 40 and may be a single component or a plurality of sub-components joined together to form the frame 38 of a particular side wall 18. The mesh material 40 may be wire mesh, bars, and/or other similar materials suitable for creating an enclosed space with openings that allow for ventilation while preventing escape of material contained within the enclosed space. Optionally, and as best illustrated in FIG. 7, at least one of the side walls 18 (e.g., the front side wall 18A in FIG. 7) need not include the mesh material 40 and instead may be a material without openings for ventilation or a solid material. In other embodiments, each side wall 18 may include the frame 38 and mesh material 40.

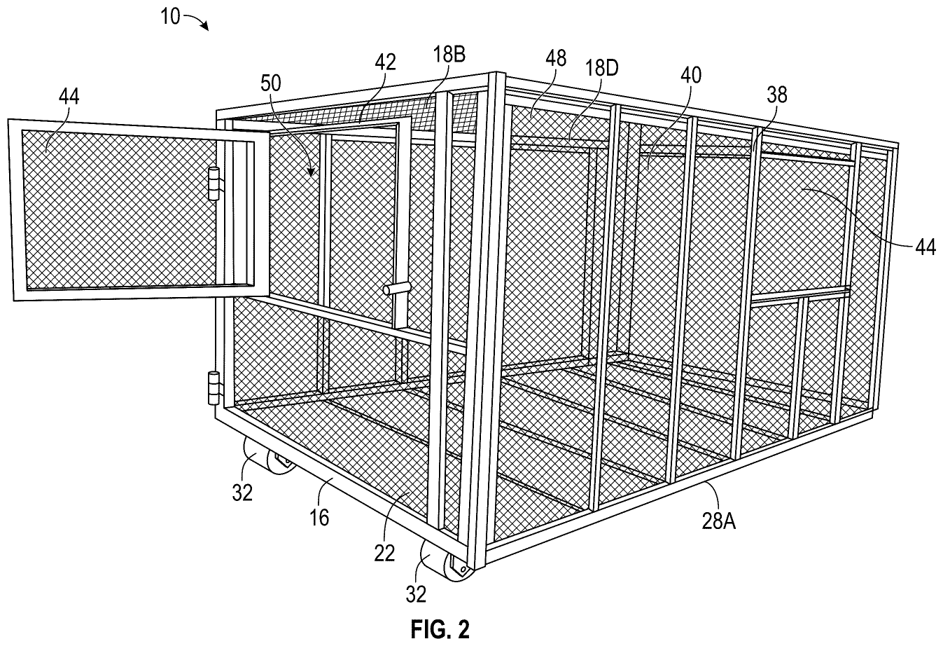

Optionally, and as illustrated FIG. 2, one or more side walls 18 includes an access opening 42 and an associated door or cover 44. As described in detail below, the access opening 42 may allow for material to be loaded into and/or unloaded from the modular trash bin 10. The shape, size, location, and number of access openings 42 and/or covers 44 should not be considered limiting. In certain embodiments, the cover 44 may have the frame and mesh material, although it may have other constructions as desired.

In various embodiments, similar to the majority of the plurality of side walls 18, the top wall 20 includes a frame 45 and mesh material 46. The frame 45 and the mesh material 46 may be the same as that used for the side walls 18, although it need not be in other embodiments.

In certain embodiments, the plurality of side walls 18 may be attached to the base 16, and the top wall 20 may be attached to the plurality of side walls 18 opposite from the base 16. As illustrated in FIGS. 1-11, the base 16, the plurality of side walls 18, and the top wall 20 define an enclosure 48 having an interior region 50 configured to receive waste material. In certain embodiments, the mesh material of the side walls and the top wall provide a cage design on all sides which provides ventilation and/or visibility into the interior region 50 while retaining material within the interior region 50.

In certain embodiments, in use, material may be loaded into the interior region 50 via the one or more access openings 42. Optionally, one of the plurality of side walls 18 may be pivotably attached and/or retained between the top wall 20 and the base 16 such that a sub-portion of a side wall 18 and/or the entire side wall 18 may selectively pivot and/or otherwise move between closed and open positions. As a non-limiting example, the back side wall 18B may be pivotably retained between the top wall 20 and the base 16 while also including an access opening 42. In these embodiments, the access opening 42 may be utilized for loading material into the enclosure (e.g., a smaller access opening 42 may provide more control of loading of material) while the entire back side wall 18B may be pivoted to an open position to facilitate unloading of material from the enclosure 48, optionally while tilting the modular trash bin 10 (see, e.g., FIG. 9). Other configurations and/or utilizations of the access openings 42 may be realized as desired, and the aforementioned example should not be considered limiting.

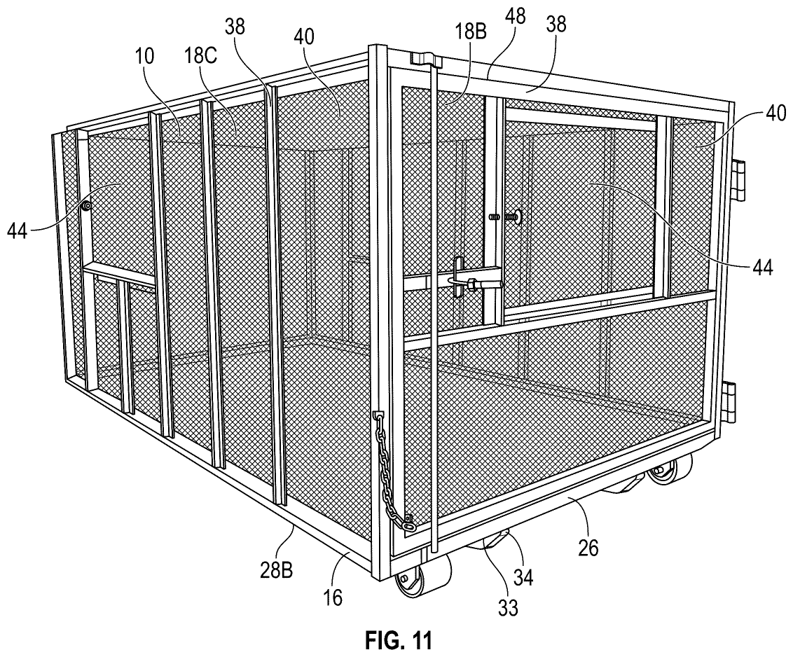

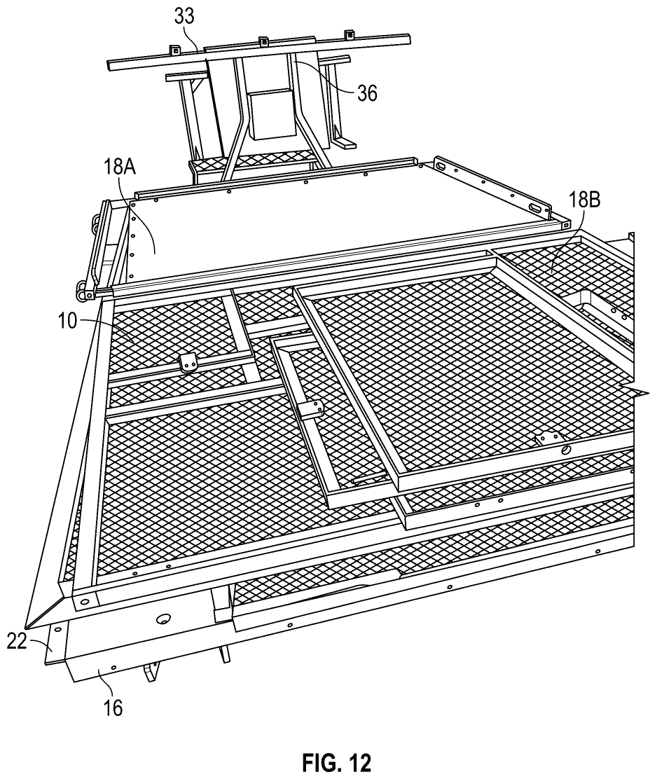

With reference to FIGS. 11 and 12, in certain embodiments, the plurality of side walls 18 and the top wall 20 may have a deployed configuration (FIG. 11) and a stowed configuration (FIG. 12) relative to the base 16. In various embodiments, in the deployed configuration, the plurality of side walls 18 and the top wall 20 may defined the enclosure 48 with the interior region 50, and in the stowed configuration, the enclosure 48 is not defined. Optionally, and as illustrated in FIG. 14, the plurality of side walls 18 and the top wall 20 may further have an intermediate configuration relative to the base 16 in which a majority of the plurality of side walls 18 are attached to the base 16 while the top wall 20 is detached from the side walls 18. Various devices or mechanisms may be utilized such that the plurality of side walls 18 and the top wall 20 are configurable between the deployed configuration and the stowed configuration (and optional intermediate configuration). As non-limiting examples, hinge mechanisms, mechanical fasteners, hooks and pins, snap-fit connections, friction fit connections, combinations thereof, and/or other systems or devices as desired may be utilized as desired.

In various embodiments, the modular trash bin 10 with the stowed and deployed configurations may allow for quick assembly and/or disassembly of the modular trash bin 10 as desired. In some embodiments, the modular trash bin 10 may be loaded and/or unloaded on the transport device 12 in the stowed configuration and/or the deployed configuration (and/or the intermediate configuration) as desired when material is not within the enclosure. Such different configurations may allow for a user to transport and/or deliver the modular trash bin 10 in various configurations as desired. As non-limiting examples, a modular trash bin 10 may be transported in the deployed configuration if a use site lacks personnel or space to change the configuration of the modular trash bin 10 and/or an anticipated use time is minimal, while a modular trash bin 10 may be transported in the stowed configuration if trained personnel are available, space is available, use of the modular trash bin 10 does not have time constraints, etc. The aforementioned example is for illustrative purposes only and should not be considered limiting.

In certain embodiments, the modular trash bin 10 with the stowed and deployed configurations may allow for improved transport of the modular trash bin 10. Optionally, the modular trash bin 10 with different configurations may allow a plurality of modular trash bins 10 to be transported by a single transport device. As non-limiting examples and with reference to FIGS. 13 and 14, the modular trash bin 10 with the detachable side walls 18 and top wall 20 may allow for a plurality of modular trash bins 10 to be transported in various configurations. As non-limiting examples, FIG. 13 illustrates a transport device 12 transporting one modular trash bin 10 in the deployed configuration and a plurality of modular trash bins 10 in the stowed configuration, and FIG. 14 illustrates the transport device 12 transporting two modular trash bins 10 in the deployed configuration and two modular trash bins 10 in the intermediate configuration. Optionally, and as illustrated in FIGS. 13 and 14, the stowed configuration and/or the intermediate configuration may facilitate stacking and/or nesting of a plurality of modular trash bins 10 as desired.

The trash bins 10 described herein provide improved modularity and may be easily and quickly assembled, disassembled, and/or stacked (e.g., for easier transport and storage of multiple units). In certain embodiments, the mesh material of the side walls and the top wall provide a cage design on all sides, which may allow for potentially hazardous materials in the enclosure to be observed without physically accessing the enclosure. In certain embodiments, the trash bins 10 described herein may be narrower in the front and wider in the back, which may facilitate dumping of material from the trash bin. The tapered shape of the trash bins 10 descried herein also allows for easier nesting, stacking, and transport of assembled units. In certain embodiments, the fork pockets of the trash bins described herein may allow a forklift to easily move units around a yard and/or otherwise provide improve transport of the trans bins described herein. Various other benefits and advantages may be realized with the systems and methods described herein, and the aforementioned benefits and advantages should not be considered limiting.

A collection of exemplary embodiments is provided below, including at least some explicitly enumerated as an “Illustration” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A modular trash bin comprising: a base; a plurality of side walls; and a top wall, wherein at least one of the top wall or one of the plurality of side walls comprise a frame and a mesh material, wherein the plurality of side walls and the top wall comprise a deployed configuration and a stowed configuration relative to the base, wherein, in the deployed configuration, the plurality of side walls and the top wall define an enclosure with the base configured to receive waste material, and wherein, in the stowed configuration, the enclosure is not defined, wherein at least one of the plurality of side walls defines an access opening for loading the waste material into the enclosure and unloading the waste material from the enclosure in the deployed configuration.

Illustration 2. The modular trash bin of any preceding or subsequent illustration or combination of illustrations, wherein, in the deployed configuration, each of the plurality of side walls is attached to the base and the top wall is attached to top ends of the plurality of side walls opposite from the base, and wherein, in the stowed configuration, the plurality of side walls are detached from the base and the top wall is detached from the plurality of side walls.

Illustration 3. The modular trash bin of any preceding or subsequent illustration or combination of illustrations, wherein at least two of the plurality of side walls define access openings.

Illustration 4. The modular trash bin of any preceding or subsequent illustration or combination of illustrations, wherein the plurality of side walls comprises a front side wall, a back side wall, and lateral side walls positionable and extending between the front side wall and the back side wall, wherein a length of the front side wall is less than a length of the back side wall.

Illustration 5. The modular trash bin of any preceding or subsequent illustration or combination of illustrations, wherein a length of the lateral side walls is greater than the length of the back side wall.

Illustration 6. The modular trash bin of any preceding or subsequent illustration or combination of illustrations, wherein the base comprises a front end, a back end, and a side between the front end and the back end, wherein the side comprises at least two fork pockets.

Illustration 7. The modular trash bin of any preceding or subsequent illustration or combination of illustrations, wherein the base comprises a front end and a back end, and wherein the back end comprises a roll-off wheel assembly.

Illustration 8. The modular trash bin of any preceding or subsequent illustration or combination of illustrations, wherein at least one of the plurality of side walls does not comprise the mesh material.

Illustration 9. A trash transport system comprising the modular trash bin of any preceding or subsequent illustration or combination of illustrations and a vehicle, wherein the modular trash bin is configured to be loaded and unloaded from the vehicle in both the deployed configuration and the stowed configuration.

Illustration 10. A trash transport system comprising a plurality of modular trash bins of any preceding or subsequent illustration or combination of illustrations and a single vehicle, wherein the single vehicles is configured to concurrently transport the plurality of modular trash bins.

Illustration 11. A modular trash bin comprising: a base; a plurality attached to the base; and a top wall attached to each of the plurality of side walls opposite from the base, wherein the top wall and a majority of the plurality of side walls each comprise a frame and mesh material, wherein the base, the plurality of side walls, and the top wall define an enclosure configured to receive waste material, wherein at least one of the plurality of side walls defines an access opening for loading the waste material into the enclosure and unloading the waste material from the enclosure, wherein the modular trash bin is separable from a trailer or vehicle configured to carry the modular trash bin.

Illustration 12. A modular trash bin comprising: a base comprising a front end, a back end, and a side extending between the front end and the back end, wherein the side comprises at least two fork pockets; a plurality of side walls attached to the base; and a top wall attached to the plurality of side walls opposite from the base, wherein the top wall and a majority of the plurality of side walls each comprise a frame and a mesh material, wherein the plurality of side walls and the top wall define a enclosure with the base configured to receive waste material, wherein at least one of the plurality of side walls defines an access opening for loading the waste material into the enclosure and unloading the waste material from the enclosure.

Illustration 13. The modular trash bin of any preceding or subsequent illustration or combination of illustrations, wherein the top wall is detachable from the plurality of side walls and the plurality of side walls are detachable from the base such that the modular trash bin comprises a deployed configuration in which the plurality of side walls and the top wall define the enclosure with the base, and a stowed configuration in which the enclosure is not defined.

Illustration 14. The modular trash bin of any preceding or subsequent illustration or combination of illustrations, wherein a width of the front end of the base is less than a width of the back end of the base.

Illustration 15. The modular trash bin of any preceding or subsequent illustration or combination of illustrations, wherein the modular trash bin is separable from a trailer or vehicle configured to carry the modular trash bin.

Illustration 16. A modular trash bin comprising: a base; a plurality of side walls, the plurality of side walls comprising a front side wall, a back side wall, and lateral side walls extending between the front side wall and the back side wall, wherein a length of the front side wall is less than a length of the back side wall; and a top wall attached to each of the plurality of side walls opposite from the base, wherein at least one of the top wall or one of the plurality of side walls comprise a frame and a mesh material, wherein the base, the plurality of side walls, and the top wall define an enclosure configured to receive waste material, and wherein at least one of the plurality of side walls defines an access opening for loading the waste material into the enclosure and unloading the waste material from the enclosure.

Illustration 17. The modular trash bin of any preceding or subsequent illustration or combination of illustrations, wherein the top wall and a majority of the plurality of side walls each comprise the frame and the mesh material.

Illustration 18. The modular trash bin of any preceding or subsequent illustration or combination of illustrations, wherein each of the top wall and the plurality of side walls comprise the frame and the mesh material.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without a letter refers to the element generically or collectively. Thus, as an example (not shown in the drawings), device “102A” refers to an instance of a device class, which may be referred to collectively as devices “102” and any one of which may be referred to generically as a device “102.”

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A modular trash bin comprising:
a base;
a plurality of side walls; and
a top wall, wherein at least one of the top wall or one of the plurality of side walls comprise a frame and a mesh material,
wherein the plurality of side walls and the top wall comprise a deployed configuration and a stowed configuration relative to the base, wherein, in the deployed configuration, the plurality of side walls and the top wall define an enclosure with the base configured to receive waste material, and wherein, in the stowed configuration, the enclosure is not defined,
wherein at least one of the plurality of side walls defines an access opening for loading the waste material into the enclosure and unloading the waste material from the enclosure in the deployed configuration.

2. The modular trash bin of claim 1, wherein, in the deployed configuration, each of the plurality of side walls is attached to the base and the top wall is attached to top ends of the plurality of side walls opposite from the base, and wherein, in the stowed configuration, the plurality of side walls are detached from the base and the top wall is detached from the plurality of side walls.

3. The modular trash bin of claim 1, wherein each of the top wall and the plurality of side walls comprise the frame and the mesh material.

4. The modular trash bin of claim 1, wherein the plurality of side walls comprises a front side wall, a back side wall, and lateral side walls positionable and extending between the front side wall and the back side wall, wherein a length of the front side wall is less than a length of the back side wall.

5. The modular trash bin of claim 4, wherein a length of the lateral side walls is greater than the length of the back side wall.

6. The modular trash bin of claim 1, wherein the base comprises a front end, a back end, and a side between the front end and the back end, wherein the side comprises at least two fork pockets.

7. The modular trash bin of claim 1, wherein the top wall and a majority of the plurality of side walls each comprise the frame and the mesh material.

8. The modular trash bin of claim 1, wherein at least one of the plurality of side walls does not comprise the mesh material.

9. A trash transport system comprising the modular trash bin of claim 1 and a vehicle, wherein the modular trash bin is configured to be loaded and unloaded from the vehicle in both the deployed configuration and the stowed configuration.

10. A trash transport system comprising a plurality of modular trash bins according to claim 1 and a single vehicle, wherein the single vehicles is configured to concurrently transport the plurality of modular trash bins.

11. A modular trash bin comprising:
a base;
a plurality attached to the base; and
a top wall attached to each of the plurality of side walls opposite from the base,
wherein the top wall and a majority of the plurality of side walls each comprise a frame and mesh material,
wherein the base, the plurality of side walls, and the top wall define an enclosure configured to receive waste material,
wherein at least one of the plurality of side walls defines an access opening for loading the waste material into the enclosure and unloading the waste material from the enclosure,
wherein the modular trash bin is separable from a trailer or vehicle configured to carry the modular trash bin.

12. The modular trash bin of claim 11, wherein the base comprises a front end, a back end, and a side between the front end and the back end, wherein the side comprises at least two fork pockets.

13. The modular trash bin of claim 11, wherein the base comprises a front end and a back end, and wherein the back end comprises a roll-off wheel assembly.

14. The modular trash bin of claim 11, wherein the plurality of side walls comprise a front side wall, a back side wall, and lateral side walls extending between the front side wall and the back side wall, wherein a length of the front side wall is less than a length of the back side wall.

15. The modular trash bin of claim 14, wherein a length of the lateral side walls is greater than the length of the back side wall.

16. A modular trash bin comprising:
a base comprising a front end, a back end, and a side extending between the front end and the back end, wherein the side comprises at least two fork pockets;
a plurality of side walls attached to the base; and
a top wall attached to the plurality of side walls opposite from the base,
wherein at least one of the top wall or one of the plurality of side walls comprise a frame and a mesh material,
wherein the plurality of side walls and the top wall define an enclosure with the base configured to receive waste material,
wherein at least one of the plurality of side walls defines an access opening for loading the waste material into the enclosure and unloading the waste material from the enclosure.

17. The modular trash bin of claim 16, wherein the top wall is detachable from the plurality of side walls and the plurality of side walls are detachable from the base such that the modular trash bin comprises a deployed configuration in which the plurality of side walls and the top wall define the enclosure with the base, and a stowed configuration in which the enclosure is not defined.

18. The modular trash bin of claim 16, wherein a width of the front end of the base is less than a width of the back end of the base.

19. The modular trash bin of claim 16, wherein the modular trash bin is separable from a trailer or vehicle configured to carry the modular trash bin.

20. The modular trash bin of claim 16, wherein the top wall and a majority of the plurality of side walls each comprise the frame and the mesh material.
